(19) United States
(12) Patent Application Publication
(10) Pub. No.: US 2007/0076522 A1
(43) Pub. Date: Apr. 5, 2007

(54) Mixing apparatus and method with ceramic impeller bearings

(75) Inventors: David Engel, Springwater, NY (US); Anthony C. Kocienski, Rochester, NY (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: SPX CORPORATION

(21) Appl. No.: 11/413,185

(22) Filed: Apr. 28, 2006

Related U.S. Application Data
(60) Provisional application No. 60/722,421, filed on Oct. 3, 2005.

(51) Int. Cl. B01F 13/08

(52) U.S. Cl. 366/273; 366/331

(57) ABSTRACT

An impeller system for a mixer is used with a vessel for holding a material to be mixed. A stationary shaft extends into the vessel. A rotor having impellers extending therefrom is supported on a ceramic roller bearing assembly that supports the rotor for rotation about the shaft. The bearing assembly has a ceramic inner race, a ceramic outer race and ceramic rolling elements. A drive system is external to the vessel to magnetically drive the rotor.

### CROSS-REFERENCE TO RELATED APPLICATIONS

This application claims priority to provisional U.S. patent application entitled, MIXING APPARATUS AND METHOD WITH CERAMIC IMPELLER BEARINGS, filed Oct. 3, 2005, having a Ser. No. 60/722,421, the disclosure of which is hereby incorporated by reference in its entirety.

### FIELD OF THE INVENTION

The invention relates generally to mixing devices and methods, and more particularly relates to mixer systems for suspending, agitating and/or circulating materials, in particular liquids or liquid suspensions, via a rotating impeller in a vessel.

### BACKGROUND OF THE INVENTION

Mixing systems are in wide use in industry. In one example of such a type of system, a vessel is provided that contains a material that is to be mixed, agitated, circulated or suspended. The material has energy imparted to it by rotating impeller blades.

In an example of such a system, the rotating impeller blades extend outwardly and upwardly from a rotating hub that is disposed inside the vessel. The rotating hub is supported by some form of bearing on a shaft that is mounted to protrude inward from an inside surface of the mixing vessel. The hub is subjected to a rotating magnetic field so it is driven by a rotating magnetic drive system that is located on the outside of the vessel. A magnetic field is produced by the magnetic drive system that acts upon the impeller hub, thereby rotating the hub and the impellers.

An example of such a system is described in U.S. Pat. No. 5,758,965 issued to Gambrill et al., and entitled, “Mixer System,” the disclosure of which is hereby incorporated by reference in its entirety.

The system described in U.S. Pat. No. 5,758,965 utilizes various arrangements of bearings for supporting the rotating impeller hub, including bearings having races formed of a metal material (for example, nickel-beryllium alloy). The bearings also have rollable elements (for example, ball bearings) formed of a ceramic (for example, silicon nitride).

Prior systems are also known which utilize metallic races and metallic bearings to support the hub. Systems such as those described above have been very satisfactory. However, there is a continual desire to have bearings with longer life and improved cleanability. The hub bearings are typically “wetted” during mixing. That is, the bearings come in contact with the material being mixed. This can be desirable because the material provides some lubrication to the bearings. However, in some applications the material may be undesirably quite corrosive to metallic parts of the bearings. This corrosion can shorten bearing life.

Due to continually increasing requirements for sterile or highly cleanable mixer operation, for example in the pharmaceutical or biotechnology industries, there is a continuing focus on the cleanability and removeability of mixer impeller systems and associated bearings. Accordingly, it is desirable that the bearings be easily cleaned, for example by spraying a cleaning fluid on them, or by immersion or steam exposure, and that the impeller and bearings be easily removed. Further, there is often a desire that the bearing be capably of “dry running”, that is running without fluid or lubrication on them. There is also a desire to increase the useful life of bearings in all conditions.

The prior art system described in the U.S. Pat. No. 5,758,965, which describes metallic bearing races, has a disadvantage that it has generally been limited to requiring an “angular contact” type of ball bearing in order to provide the service life needed in many applications. FIG. 4 of U.S. Pat. No. 5,758,965 shows such an angular contact type of ball bearing. A disadvantage of the need for an angular contact type of bearing is that when the loads are asymmetrical, (not always acting in one direction), undesirably accelerated bearing wear sometimes occurs.

Therefore, it would also be desirable to have a mixing system that has a durable and cleanable bearing that can also take advantage of the benefits of other configurations of other bearings geometries in addition to angular contact bearings.

### SUMMARY OF THE INVENTION

The foregoing needs are met, to a great extent, by the present invention, wherein in one aspect an apparatus is provided that in some embodiments provides an impeller system for a mixer, comprising a stationary shaft, a rotor having impellers extending therefrom, and a ceramic roller bearing assembly that supports the rotor for rotation about the shaft, the bearing assembly having a ceramic inner race, a ceramic outer race and ceramic rolling elements. The ceramic roller elements may be balls, and the bearing may be a deep groove type rolling bearing.

In accordance with another embodiment of the present invention, an impeller system for a mixer, comprises a vessel for holding a material to be mixed, a stationary shaft extending into the vessel, a rotor having impellers extending therefrom, a ceramic roller bearing assembly that supports the rotor for rotation about the shaft, the bearing assembly having a ceramic inner race, a ceramic outer race and ceramic rolling elements, and a drive system external to the vessel to magnetically drive the rotor. In some embodiments, the ceramic roller elements may be balls, and the bearing may be a deep groove type rolling bearing.

In accordance with another embodiment of the present invention, an impeller system for a mixer, comprises a stationary shaft, a rotor having impellers extending therefrom, and an all ceramic bearing means for supporting the rotor for rotation about the shaft, the bearing means having a ceramic inner race, a ceramic outer race and ceramic rolling elements. In some embodiments, the ceramic roller elements may be balls, and the bearing may be a deep groove type rolling bearing.

In accordance with yet another embodiment of the present invention, a method of driving an impeller system for a mixer, comprises holding a material to be mixed in a vessel, supporting a rotor having impellers extending therefrom on a stationary shaft using a ceramic roller bearing assembly having a ceramic inner race, a ceramic outer race and ceramic rolling elements, and magnetically driving the rotor using a drive system external to the vessel. In some embodiments, the ceramic roller elements may be balls, and the bearing may be a deep groove type rolling bearing.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a layout/cross-sectional view of an impeller, impeller bearings, and impeller drive system according to a preferred embodiment of the present invention.

FIG. 2 is a cross-sectional view of a ceramic deep groove ball bearing assembly with ceramic balls and ceramic races.

### DETAILED DESCRIPTION

Various embodiments of the present invention provide a mixer having an impeller hub supported via one or more completely all-ceramic bearings. That is, the bearings have inner and outer races, both of which are made of a ceramic material, and also utilize ceramic rolling elements, for example ceramic balls.

One or more sets of these bearings may be provided, and the bearings may be caged or uncaged. Further, either a full complement or a partial complement of balls may be provided in each set of the races. A benefit to the use of all-ceramic bearings is that the ceramic material permits the use in some embodiments of “deep groove” ball bearing structures in place of partially metallic angular contact bearings.

The ability to use deep groove bearings as an alternative to angular contact bearings in many applications provides better life, particularly in applications where the loads are not always in the same direction during operation.

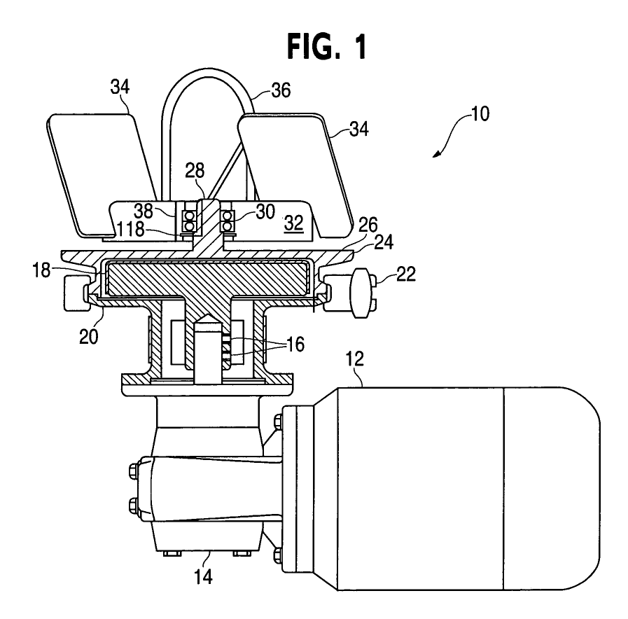

FIG. 1 depicts an impeller and impeller drive system 10 according to a preferred embodiment of the present invention. The system 10 includes a motor 12 which drives a speed reducer 14 connected thereto.

The speed reducer 14 has an output shaft that is connected by one or more set screws 16 to a magnetic drive rotor 18. Thus, it will be appreciated that the magnetic drive rotor 18 is in effect supported by bearings (not shown) which are located in the speed reducer 14. The magnetic drive rotor 18 has either a number of magnets or one large magnet disposed either around or in the drive rotor 18 so that rotation of the magnet drive rotor 18 creates a rotating magnetic field thereabout.

A clamp plate adaptor 20 is provided which is attached to the speed reducer 14 and acts as a pedestal so that a clamp 22 can attach the clamp plate adaptor 20 to a tank plate 24. The tank plate 24 serves as a fixture that can be welded into a similarly size aperture in a tank (or vessel) so that the motor 12, speed reducer 14, and clamp plate adaptor 20 are all located exterior to the tank. The tank plate 24 has an inner surface 26 which will be exposed to the material that is inside the vessel.

Projecting inward into the tank from the inner surface 26 is a stub shaft 28. The stub shaft 28 supports one or more bearing assemblies 30. In the embodiment illustrated in FIG. 1, two bearing assemblies 30 are stacked directly on top of each other. These bearing assemblies 30 are retained by a shoulder on the stub shaft 28 and also by an opposed shoulder on an impeller disk 32.

The impeller disk 32 supports a number of impeller blades 34. A grasping loop 36 may also be provided to facilitate lifting of the impeller for disassembly.

The impeller disk 32 is made of a material that is subject to magnetic fields, such that rotation of the magnetic drive rotor 18 causes a magnetic field that tends to rotate the impeller disk 32, and hence rotate the impeller blades 34. Optionally, flow channels 38 can be provided through the impeller disk 32, which flow channels may be similar to the flow channels in U.S. Pat. No. 5,758,965.

A feature of the invention is the combination of the use of all-ceramic bearings 30 in a magnetic driven impeller system. These all-ceramic bearings 30 may be made of any ceramic (nonmetallic) material, but preferably may be made of for example silicon nitride, or zirconium oxide. The use of all-ceramic bearings 30 avoids the need for any metallic bearing contact elements. This means, in at least some applications, that the bearings 30 can be more resistant to corrosion and/or wear than would be comparable bearings with metal elements.

Another significant advantage of the use of all-ceramic bearings is that the ceramic material permits the use of deep groove ball bearings in place of angular contact bearings, in applications which previously required angular contact bearings. The all-ceramic bearings 30 also provide greater life in some applications than metal bearings.

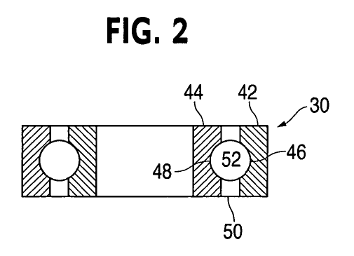

FIG. 2 is a cross-sectional view of a ceramic deep groove ball bearing assembly with ceramic balls and ceramic races. FIG. 2 illustrates the bearing 30 having an outer race 42 and an inner race 44. The outer race 42 has a relatively deep groove 46 and the inner race 44 has a relatively deep groove 48. Both of these grooves are symmetrical, the groove has similar depth with respect to both the top and the bottom of the bearing. A channel 50 is formed between the outer race 42 and inner race 44. An exemplary ball bearing element 52 is illustrated.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents maybe resorted to, falling within the scope of the invention.

What is claimed is:

1. An impeller system for a mixer, comprising:
a stationary shaft;
a rotor having impellers extending therefrom; and
a ceramic roller bearing assembly that supports the rotor for rotation about the shaft, the bearing assembly having a ceramic inner race, a ceramic outer race and ceramic rolling elements.

2. The system of claim 1, wherein the ceramic rolling elements are balls.

3. The system of claim 1, wherein the bearing is a deep groove type bearing.

4. The system of claim 1, wherein the ceramic inner race, the ceramic outer race and the ceramic rolling elements are each made of silicon nitride.

5. The system of claim 1, wherein the ceramic inner race, the ceramic outer race and the ceramic rolling elements are each made of zirconium oxide.

6. An mixer system, comprising:
a vessel for holding a material to be mixed;
a stationary shaft extending into the vessel;
a rotor having impellers extending therefrom;
a ceramic roller bearing assembly that supports the rotor for rotation about the shaft, the bearing assembly having a ceramic inner race, a ceramic outer race and ceramic rolling elements; and
a drive system external to the vessel to magnetically drive the rotor.

7. The system of claim 6, wherein the ceramic rolling elements are balls.

8. The system of claim 6, wherein the bearing is a deep groove type bearing.

9. The system of claim 6, wherein the ceramic inner race, the ceramic outer race and the ceramic rolling elements are each made of silicon nitride.

10. The system of claim 6, wherein the ceramic inner race, the ceramic outer race and the ceramic rolling elements are each made of zirconium oxide.

11. An impeller system for a mixer, comprising:
a stationary shaft;
a rotor have an impellers extending therefrom; and
an all ceramic bearing means for supporting the rotor for rotation about the shaft, the bearing means having a ceramic inner race, a ceramic outer race and ceramic rolling elements.

12. The system of claim 11, wherein the ceramic rolling elements are balls.

13. The system of claim 11, wherein the bearing means is a deep groove bearing type.

14. The system of claim 11, wherein the ceramic inner race, the ceramic outer race and the ceramic rolling elements are each made of silicon nitride.

15. The system of claim 11, wherein the ceramic inner race, the ceramic outer race and the ceramic rolling elements are each made of zirconium oxide.

16. A method of driving an impeller system for a mixer, comprising:
holding a material to be mixed in a vessel;
supporting a rotor having an impellers extending therefrom on a stationary shaft using a ceramic roller bearing assembly having a ceramic inner race, a ceramic outer race and ceramic rolling elements; and
magnetically driving the rotor using a magnetic drive system external to the vessel.

17. The method of claim 16, wherein the ceramic rolling elements are balls.

18. The method of claim 16, wherein the bearing is a deep groove bearing type.

19. The method of claim 16, wherein the ceramic inner race, the ceramic outer race and the ceramic rolling elements are each made of silicon nitride.

20. The method of claim 16, wherein the ceramic inner race, the ceramic outer race and the ceramic rolling elements are each made of zirconium oxide.
